(19) United States
(12) Patent Application Publication
(10) Pub. No.: US 2015/0263667 A1
(43) Pub. Date: Sep. 17, 2015

(54) SUNLIGHT-COLLECTING SYSTEM

(71) Applicant: National Taiwan Normal University, Taipei City (TW)

(72) Inventors: TUN-CHIEN TENG, Taipei City (TW); WEI-CHE LAI, Taipei City (TW)

(21) Appl. No.: 14/471,931

(22) Filed: Aug. 28, 2014

(30) Foreign Application Priority Data
Mar. 13, 2014 (TW) 103109161

(51) Int. Cl. H02S 40/22

(52) U.S. Cl. CPC H02S 40/22

(57) ABSTRACT

A sunlight-collecting system is disclosed, which includes a plurality of lenses changing the angle of an incident sunlight, a wedged light guide plate (LGP) receiving the incident sunlight passing through a lens of the plurality of lenses and a holder fixing the lens of the plurality of lenses at a desired position corresponding the LGP. The structures, materials and desired positions of the lens and LGP make the incident sunlight passing through the lens and then going into the LGP perform total internal reflection (TIR) transmission in the LGP and then concentrate at one end of the LGP. The present sunlight-collecting system changes the corresponding lens to the desired position to keep the above TIR transmission condition, depending on the initial angle of the incident sunlight. In other words, the present sunlight-collecting system collects sunlight by changing corresponding lens instead of using sunlight tracking methods.

### CROSS-REFERENCE TO RELATED APPLICATION

This application claims the benefit of Taiwan Patent Application No. 103109161, filed on Mar. 13, 2014, in the Taiwan Intellectual Property Office, the disclosure of which is incorporated herein its entirety by reference.

### BACKGROUND OF THE INVENTION

1. Field of the Invention

The prevent invention relates to a sunlight-collecting system, in particular respect to a non-solar tracking sunlight-collecting system.

2. Description of the Related Art

For the sake of the fossil fuels is running out, many researchers and technicians are looking for a stable investment in renewable energy as an alternative. In a variety of renewable energy sources, solar power is the most promising one. With the progress of engineering technology, the cost of solar power is low and has reached the practical stage; however, to further improve the efficiency of solar power is still desirable. Currently, the way to improve the efficiency of solar power in addition to directly change the efficiency of solar cells, there is an additional set of solar power systems in the light-collecting system, thereby improving the overall spatial efficiency of solar power system, so that the incidence of sunlight is concentrated to an effective power region of solar cells. In addition, for the incidence of sunlight in the same area of the solar power system, an additional set of sunlight-collecting system allows solar power system can reduce required solar cell materials, thus achieving the effect of reducing costs.

In addition to applying to solar power directly, as the effectiveness of the light-collecting system is to concentrate the incident sunlight from a large area to a smaller area, so in the sun, the light-collecting system can do a primary or assistant to indoor lighting, taking a step forward to achieve the effect of green energy.

Currently, the conventional light-collecting systems are mostly based on mechanical tracing manner that is generally known solar tracking light-collecting system. That is, when the position of the sun changes with time, the light-collection system with mechanical rotation device rotates a light-collecting plate or lens to keep the overall collection efficiency of the system according to the rotating position of the sun. The sun path in the sky is not always on the same plane, such as the planes formed by sun path as the winter solstice and the summer solstice are not the same; it is generally that conventional light-collecting system must have a mechanical structure which capable of at least biaxial rotation. However, this mechanical structure is complex, and therefore may increase the cost of production or installation of light-collecting system, the probability of malfunction and the required space of light-collecting system.

In addition, the general light-collecting systems may use light guide to achieve light transmission and concentration, but because of the common light guide may produce decoupling losses due to the built-in coupler or gaps. Consequently, in terms of light-collecting systems, it is desired to reduce losses to improve efficiency, and maintaining the optical transmission or light-collecting effects of the light guide is also needed.

### SUMMARY OF THE INVENTION

In view of the aforementioned conventional shortcoming, the objective to the present invention is to provide a non-solar tracking sunlight-collecting system to solve the current defect caused by a mechanical structure of a solar tracking sunlight-collecting system.

According to one objective of the present invention, it provides a sunlight-collecting system, comprising: a plurality of lenses changing the angle of an incident sunlight; a wedged light guide plate (LGP) receiving the incident sunlight passing through a lens of the plurality of lenses; and a holder fixing the lens of the plurality of the lenses at a desired position corresponding the LGP; wherein, the structures, materials and desired position of the lens and LGP make the incident sunlight passing through the lens and then going into the LGP perform total internal reflection (TIR) transmission in the LGP and then concentrate at one end of the LGP, and the sunlight-collecting system changes the corresponding lens to the desired position to keep the above TIP transmission condition, depending on the initial angle of the incident sunlight.

Preferably, the plurality of lenses are of different structures, so that different angle changes occur while the incident sunlight passes through the plurality of lenses.

Preferably, the plurality of lenses are made of different materials, so that the different angle changes occur while the incident sunlight passes through the plurality of lenses.

Preferably, the plurality of lenses are structured in different prism arrays or cylindrical arrays.

Preferably, the plurality of lenses are a plurality of membrane lenses.

Preferably, the plurality of lenses are flexible and assembled upon a type or form a type, the type is assembled upon the holder, the holder is a roller structure, so that the sunlight-collecting system replaces the lens of the plurality of lenses corresponding the incident sunlight by scroll.

Preferably, the holder rotates the lens corresponding to an angle of the incident sunlight, so that the incident sunlight passing through the lens is collimated.

Preferably, the sunlight-collecting system may replace the lens with a corresponding structure, so that the incident sunlight passing through the lens is collimated.

Preferably, the sunlight-collecting system may implement multiple axis rotation to rotate the lens.

According to the above description, the sunlight-collecting system of the present invention may have one or more advantages as follows:

(1) The sunlight-collecting system can replace the corresponding lens depending on the angle of incident sunlight so that it can thereby avoid the use of complex mechanical solar-tracking devices and the aforementioned disadvantages.

(2) This sunlight-collecting system can use wedge-shaped light guide to perform totally reflect transmission of sunlight therein and thereby resolves the problem of decoupling losses occurred inside the conventional light guide.

(3) This sunlight-collecting system can use the membrane lens and the type structure, thereby allow the sunlight-collecting system being easily miniaturized and applied to personal portable devices for use.

(4) This sunlight-collecting system can use scrolling device along with flexible membrane lens, thereby make the sunlight-collecting system easily perform the replacement of the lens.

(5) This sunlight-collecting system can replace the lens with specific structure or rotate the lens, thereby allow the sunlight-collecting system can be collimated, even with the solar orbit changing with a date or seasonal variations in the sky, the sunlight-collecting system can maintain in high light-collecting efficiency.

### BRIEF DESCRIPTION OF THE DRAWINGS

FIGS. 1A and 1B are operating schematic diagrams of the first embodiment of different sunlight incident angles of a sunlight-collecting system of the present invention.

FIGS. 2A and 2B are operating schematic diagrams of the second embodiment of different sunlight incident angles of a sunlight-collecting system of the present invention.

FIG. 3 is an operating schematic diagram of the third embodiment of a sunlight-collecting system of the present invention.

FIG. 4 is a structural schematic diagram of the forth embodiment of a sunlight-collecting system of the present invention.

FIGS. 5A and 5B are overlooking structural schematic diagrams of the lenses with different structures of the fifth embodiment of the present invention.

FIGS. 6A and 6B are overlooking schematic diagrams illustrating a wedged light guide plate and the sunlight passing through lenses with different structures in FIGS. 5A and 5B, respectively.

FIGS. 7A and 7B are structural schematic front views of the sixth embodiment of different lenses' rotation angles of a sunlight-collecting system of the present invention.

FIGS. 8A to 8C are structural schematic side views of the sixth embodiment of different lenses' rotation angles of a sunlight-collecting system of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

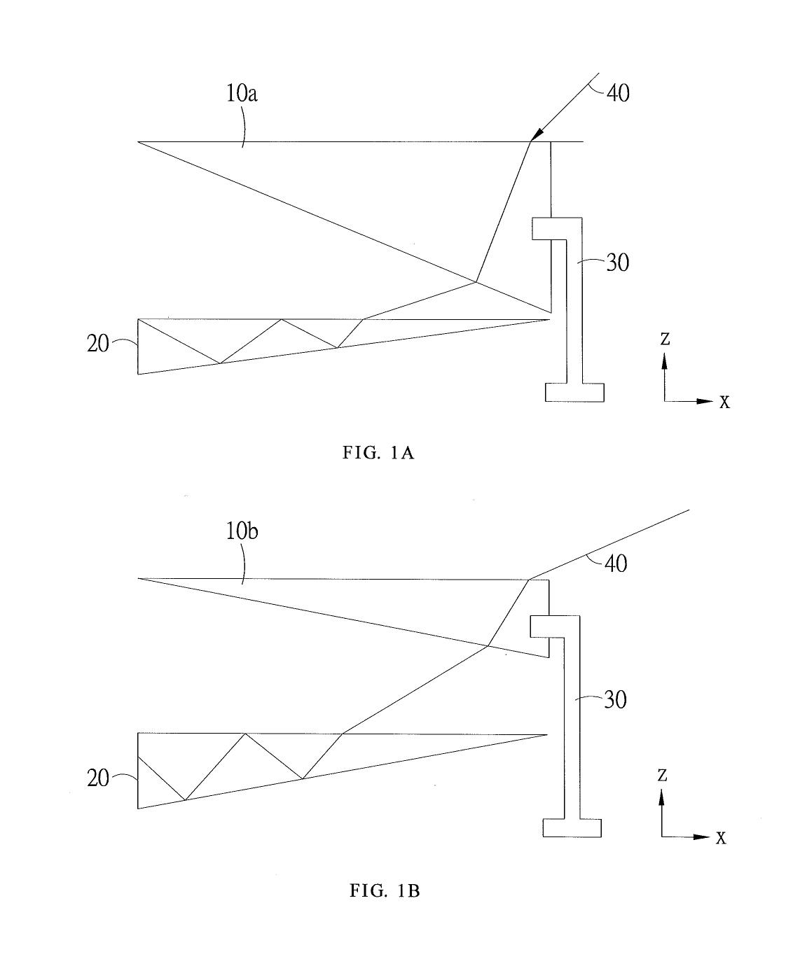

Please refer to FIGS. 1A and 1B which are operating schematic diagrams of the first embodiment of different sunlight incident angles of a sunlight-collecting system of the present invention. As the FIGS. show, the sunlight-collecting system comprises a plurality of lenses 10a and 10b changing the angle of an incident sunlight 40; a wedged light guide plate 20 receiving the incident sunlight 40 passing through plurality of lenses 10a and 10b; and a holder 30 fixing the lens of the plurality of the lenses 10a and 10b at a desired position corresponding the wedged light guide plate 20; wherein, the structures, materials and desired position of the lens and the wedged light guide plate 20 make the incident sunlight passing through the lens 10a and 10b and then going into the wedged light guide plate 20 to perform total internal reflection (TIR) transmission in the wedged light guide plate 20 and then concentrate at one end of the wedged light guide plate 20, and the sunlight-collecting system changes the corresponding lens 10a and 10b to the desired position to keep the above TIP transmission condition, depending on the initial angle of the incident sunlight 40.

Generally, the sunlight-collecting system of the present invention uses bevel angle of the wedged light guide plate 20 correlating with different lenses to achieve high efficiency of light-collecting. More specifically, setting the cross sections of FIGS. 1A and 1B as section X-Z in normal three dimensional coordinate, upper of the FIGS. is Z-axis direction, and angle of the incident sunlight is shown by two angles (θ, φ) in spherical coordinate, and X, Y and Z of the three dimensional coordinate will be used to denote directions in the following FIGS. FIG. 1A shows that when the incident sunlight 40 is of angle (30, 0), it is the operation of the first embodiment of the sunlight-collecting system of the present invention. Please refer to FIG. 1A, the lens 10a which is fixed on a desired position of the wedged light guide plate 20 by the holder 30 is akin to the wedged light guide plate 20. When the incident sunlight 40 passing through the lens, the incident sunlight 40 respectively has a refraction while passing in and out the lens 10a, so as to have a certain deflection angle After the incident sunlight 40 has an incidence to the wedged light guide plate 20 by the deflection angle and contacts with the interface between the wedged light guide plate 20 and external environment(e.g. the wedged light guide plate 20—air interface, refractive index of the material of external environment of the wedged light guide plate 20 is lower than that of the material of the wedged light guide plate 20). To the reflection, the incident angle is higher than the critical angle, the total reflection occurs when light is reflected back to the wedged light guide plate 20. According to the structure of the wedged light guide plate 20, the incident sunlight 40 keeps transmitting in the wedged light guide plate 20 and eventually reaches an end of the wedged light guide plate 20 (X direction shown in FIG. 1A) so as to achieve the function of the sunlight-collecting system of the present invention. That is to say, the sunlight is concentrated to an end of the wedged light guide plate 20 from the light-receiving surface of the lens 10a. Please refer to FIG. 1B, when the incident angle of the incident sunlight 40 changes to (60, 0) with times, the lens 10b the sunlight-collecting system of the embodiment is fixed on a desired position of the lens 10a shown in FIG. 10a by the holder 30, and the shape of the lens 10b is wedged, too, but the inclined angle is not the same as that of lens 10a. When the incident sunlight 40 passes through the lens 10b, it will penetrate the wedged light guide plate 20 by the same angle, accordingly, the incident sunlight 40 will be transmitted to an end of the wedged light guide plate 20 by total reflection as shown in FIG. 1A. In FIGS. 1A and 1B, the desired positions of the wedged light guide plate 20, the holder 30 and the fixed lens 10a and 10b are unchangeable, the possibility of modifying the incident angle of sunlight is that different lenses 10a and 10b are used, only. In other words, under the circumstance of the shape of the wedged light guide plate 20 has enabled the incident sunlight 40 of certain incident angle totally reflecting inside the wedged light guide plate 20 and the position of the wedged light guide plate 20 is fixed, the main controllable variability is the incident angle of the wedged light guide plate 20, and replacement for lens enables the incident angle of the incident sunlight 40 which penetrates the wedged light guide plate 20 can be maintained within the angle range of the total reflection transmission inside the wedged light guide plate 20; namely, the incident sunlight 40 can contact with the wedged light guide plate 20 while being transmitted in the wedged light guide plate 20 and the incident angles of the external interface are all higher than the critical angle (all the refractive indexes of the wedged external interface materials are smaller than that of the wedged light guide plate 20). If the external side of the wedged light guide plate 20 contacts with different materials so as to cause different interface critical angle, while the sunlight contacts with the wedged light guide plate 20 by a certain angle range, the structure of the wedged light guide plate 20 has to be designed as the largest critical angle which the incident angle of the external interface is higher than that of different interface critical angles during light being transmitted in the wedged light guide plate 20, and the lens can thereby maintain the angle which the sunlight 40 penetrates the wedged light guide plate 20 in the range of the total reflection transmission occurring in the wedged light guide plate 20. Therefore, the sunlight-collecting system of the present invention can maintain the high efficiency of sunlight collection aimed at different angles without mechanical device of rotation function.

On the other hand, the wedged light guide plate 20 used in the present invention enables light transmission and concentrating in the wedged light guide plate 20 by total reflection, and the end of the wedged light guide plate 20 used to concentrate light can be set for the installation of solar cell or as light for lightening without containing any couplers being assembled therein. As the ideal total reflection transmission shall have no loss, so it will not have decoupling losses caused by coupler or gaps in light guide and can further promote the efficiency of the sunlight-collecting system of the present invention.

Additionally, in the present embodiment, the material of the lens 10a and 10b can be transparent materials, such as glasses, polymer resin and so on, and the material of the wedged light guide plate 20 can be transparent materials, such as glasses, polymer resin and so on, too. The structures of the lenses 10a and 10b and the wedged light guide plate 20 (e.g. inclined angle) can be decided by the predetermined angle of receiving sunlight, materials of the lenses 10a and 10b and the wedged light guide plate 20 and the relative positions between the lenses 10a and 10b and the wedged light guide plate 20. What has to be explained is that although only two lenses are mentioned in the present embodiment, the amount of the lenses can be added based on the practical need; generally, the more amount the lenses used, the better optimal effect the angle of incident sunlight can be made (because the distributed time for each lens is decreased such that the permitted error which each lens needs reduces so as to make more precise need for lens), so that better sunlight-collecting efficiency can be achieved.

Furthermore, the plurality of lenses are of different structures, so that different angle changes occur while the incident sunlight passes through the plurality of lenses.

More specifically, the above-mentioned different structures of the lenses cause that the sunlight of different incident angles propagates by total reflection in the wedged light guide after passing out of the lenses. For example, as FIGS. 1A and 1B show, the lenses 10a and 10b are of different structures (different wedged inclined angle).

Furthermore, the plurality of lenses are made of different materials, so that the different angle changes occur while the incident sunlight passes through the plurality of lenses.

More specifically, according to the Snell's law, if deflecting light's angle is desired, other than modifying the included angle of the incident light and the plate (e.g. modifying structure), the refractive index can also be modified (e.g. modifying material). However, the conventional modification of the material has little change of the refractive index, but it can still be used to manufacture the sunlight-collecting system of high efficiency and reduce cost. According to the aforementioned description, promotion of the system's efficiency or optimum of the system can be achieved by using more lenses, but if all the used lenses are of different structures, more molds and masks are needed according to the manufacturing process. At this moment in time, it can consider that by using lenses of the same structures and different materials to achieve deflecting the incident sunlight in a small angle to make the total reflection transmission in the wedged light guide so as to save the usage of mold or mask while manufacturing lenses.

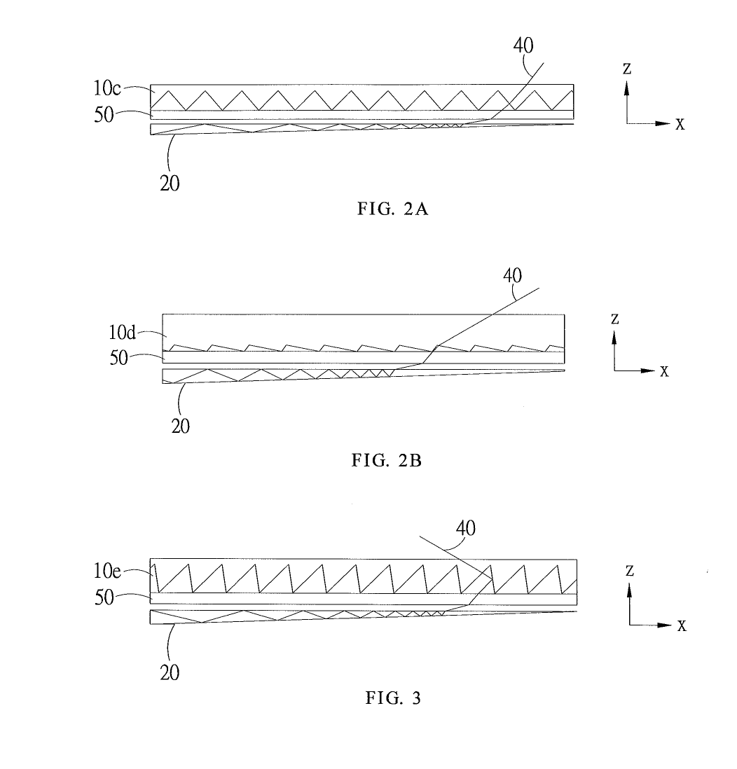

Please refer to FIGS. 2A and 2B which are operating schematic diagrams of the second embodiment of different sunlight incident angles of a sunlight-collecting system of the present invention. The plurality of lenses 10c and 10d are structured in different prism arrays or cylindrical arrays. The functions of the wedged light guide plate 20 and the incident sunlight 40 are the same as that of FIGS. 1A and 1B and the holder 30 is not shown for avoid blurring the theme of the figure. The lenses 10c and 10d can also be set on a substrate 50 for preventing the structure being damaged.

More specifically, it is inconvenient to manufacture or replace by using wedged structure as lens, for example, when the area of lens becomes large, it gets damage easily or not being manufactured practically because that an end of wedged lens is too thick. Therefore, the lenses 10c and 10d can be structured in different prism arrays or cylindrical arrays to maintain sunlight 40 in total reflection in the wedged light guide plate 20 while most incident sunlight 40 passing through the deflected angles of the different prism arrays or cylindrical arrays, and maintains the thickness of the lens so as to benefit from manufacturing or assembling conveniently. As FIG. 2A shows, when the angle of the incident sunlight 40 is (30, 0), it enables the lower surface of the lens 10c having a deeper prism surface, and in FIG. 2B, when the angle of the incident sunlight 40 is (60, 0), it enables the lower surface of the lens 10d having a more shallow prism surface. The lenses 10c and 10d of different structures enable all the sunlight having different incident angles to achieve total reflection in the wedged light guide plate 20, and the thicknesses of the lenses 10c and 10d are akin. In order to avoid the prism arrays or cylindrical arrays from damaging as external force or meet the need for the manufacturing, the prism arrays or cylindrical arrays are further separated apart outside by the substrate 50 to prevent the external force directly contacting with the prism arrays or cylindrical arrays so that the structures of prism arrays or cylindrical arrays are damaged and reduces the light-collecting efficiency, or can manufacture the lenses having aforementioned structures more conveniently. But it has to take the effectiveness of the deflection light of the substrate 50 into account while the structure of the sunlight-collecting system is being designed.

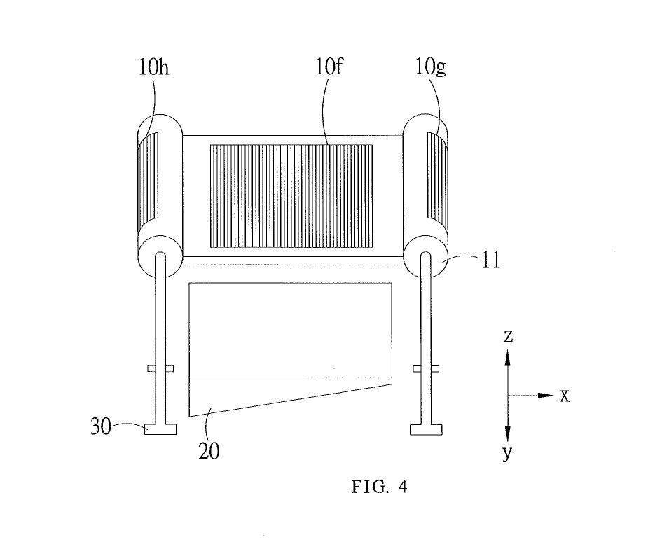

Please refer to FIG. 3 which is an operating schematic diagram of the third embodiment of a sunlight-collecting system of the present invention.

Additionally, although the deflection to the incident sunlight 40 is conducted by refraction, the reflection can be practically contained in the light path of which that sunlight reaches to the wedged light guide plate 20 through the lenses. For example, the lens 10e in the present embodiment as shown in FIG. 3, the incident sunlight 40 is of angle (60, 180), while passing through the lens 10e, the incident sunlight 40 is reflected out of one surface of a prism of the prism arrays and then is reflected from another surface of the prism, so that the incident sunlight 40 passes through the substrate 50 beneath the lens 10e and in total reflection transmission after penetrating the wedged light guide plate 20. Reflection included in the light path in which the sunlight 40 passes through lens 10c enables the sunlight deflecting in a larger angle, for example, as FIG. 3 shows, the incident sunlight 40 deflects over 90 degree so that the whole design of the sunlight-collecting system is more flexible.

Furthermore, the plurality of lenses of the sunlight-collecting system is a plurality of membrane lenses.

Recently, as the rapid development of semiconductor and nano manufacturing processes, the lenses of the sunlight-collecting system of the present invention can be manufactured by technology of production of thin-film conducted in semiconductor and nano manufacturing processes to accomplish the membrane lenses. Because the manufacturing process thereof uses the developed means, it is expected to further lower cost and enable to manufacture greatly. Additionally, using membrane lenses as the lenses of the prevent invention can also easily minimize the sunlight-collecting system of the present invention so as to cooperate with the other structures or systems (i.e. system for detecting incident angle of sunlight) and be applied to smaller device, such as personal mobile device. At this moment in time, the material of the plurality of lenses can be UV resin or Polymethylmethacrylate (PMMA), and the material of wedged light guide plate can be made of corresponding PMMA, as well.

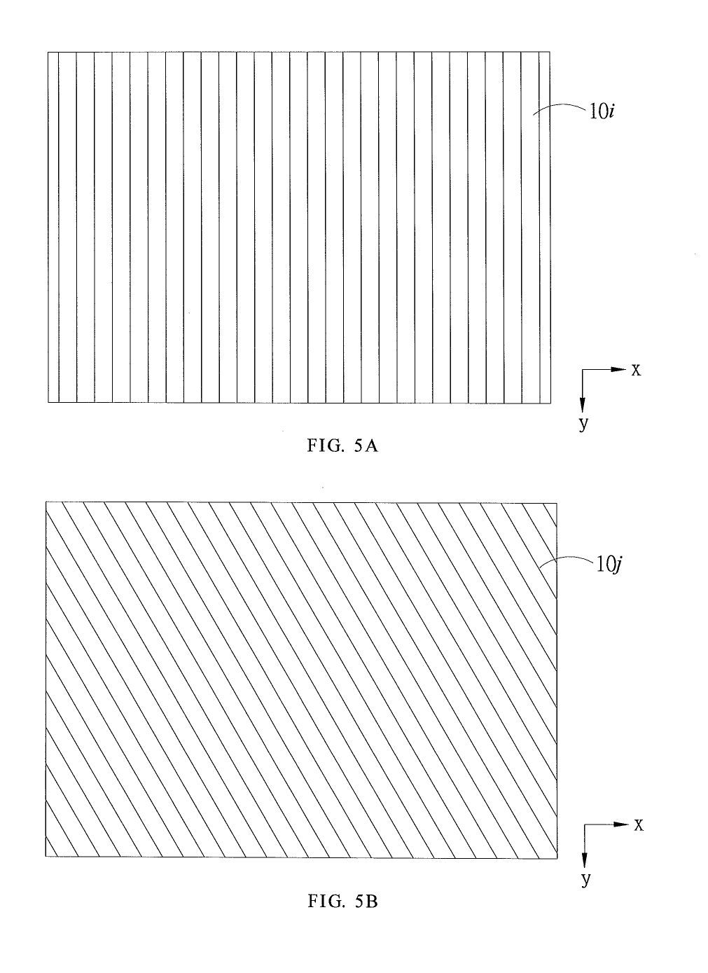

Please refer to FIG. 4 which is a structural schematic diagram of the fifth embodiment of a sunlight-collecting system of the present invention. As the FIG. shows, the plurality of lenses 10f, 10g and 10h of the sunlight-collecting system are flexible and assembled upon a type 11 or form the type 11, the type 11 is assembled upon the holder 30, the holder 30 is a roller structure, so that the sunlight-collecting system replaces the lens of the plurality of lenses 10f, 10g and 10h corresponding the incident sunlight by scroll to a desired position.

More specifically, the present embodiment describes how to easily replace corresponding lenses according to the angle of incident sunlight. As FIG. 4 shows, the plurality of lenses 10f, 10g and 10h are flexible and assembled upon the type 11. The holder 30 is a roller structure substantially, when the angle of the incident sunlight changes, rolling the roller to move the corresponding lenses from the scroll formed by the type 11 to the position of the middle lens 10f as shown in FIG. 4 and spreading them, so that the incident sunlight passes through the lens and penetrates the wedged light guide plate 20 beneath the lens and conducts the preceding total reflection transmission in the wedged light guide plate 20. It is noticeable that although FIG. 4 only shows that three lenses 10f, 10g and 10h are assembled upon the type 11, the type 11 is applicable to assemble more lenses thereon, practically, or the plurality of the lenses substantially are continuous structures and form the type per se. The sunlight-collecting system of the present invention can assemble a driving member on the holder 30, additionally; and to cooperate with system for detecting angle of sunlight to further reach function of automatically replacing corresponding lenses according to the angle of sunlight.

Moreover, the sunlight-collecting system may replace the lens with a corresponding structure, so that the incident sunlight passing through the lens is collimated.

Generally, the trajectory of the sun in the sky will vary depending on the variation of the date or the season, for example, the trajectory of the sun has distinct difference between summer solstice and winter solstice, which is also the main reason why the sunlight-collecting system of prior art requires two-axis rotation function. However, the replacing with lens of the sunlight-collecting system of the present invention may substantially substitute the two-axis rotation function of that of the prior art, and thus the inconvenience for installation, low reliability and high production cost due to complex mechanical structure may be decreased. The embodiment of collimation of the sunlight will be described in detail later.

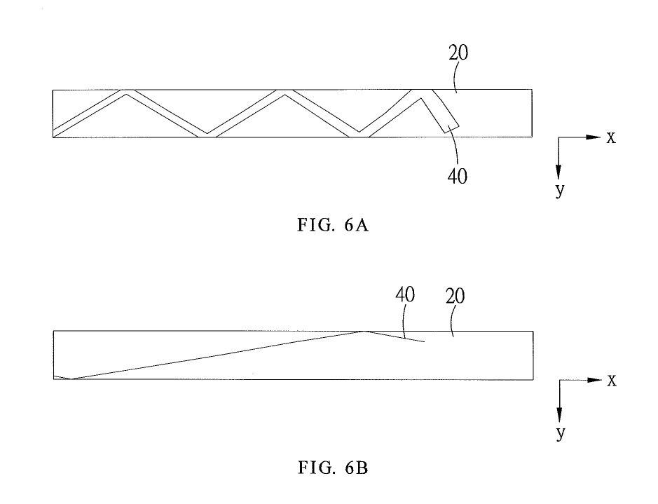

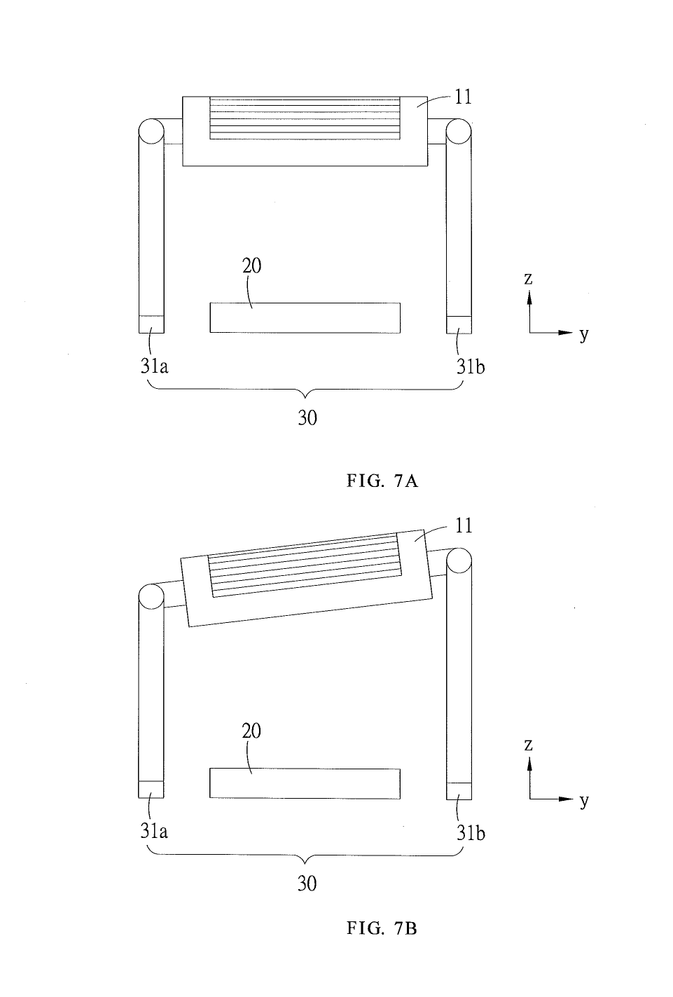

Please refer to FIGS. 5A and 5B which are overlooking structural schematic diagrams of the lenses 10i and 10j with different structures of the fifth embodiment of the present invention, and FIGS. 6A and 6B which are overlooking schematic diagrams illustrating a wedged light guide plate and the sunlight passing through lenses 10i and 10j with different structures in FIGS. 5A and 5B, respectively. What should be noticed is that FIGS. 5A, 5B, 6A and 6B are overlooking structural schematic diagrams, so the direction thereof is not akin to that of the preceding figures; besides, through the structure of the lens 10i in FIG. 5A seems like that of the lens 10j in FIG. 5B after rotation, the angle of prism structures of the lenses 10i and 10j may be substantially different from each other in X-Z plane.

Please refer to FIG. 5A which is the schematic diagram illustrating the lens 10i capable of making the sunlight 40 keep the total reflection condition in the wedged light guide plate 20 as the sunlight 40 incomes from angle (30, 0) in an expanding state. The figure surface refers to a film surface, the extending direction of single prism thereof is parallel to Y-axis, the arranging direction of prism thereof is vertical to Y-axis, and the normal vector of the film surface is parallel to Z-axis. FIG. 6A shows the case where the sunlight 40 is incident into and propagates in the wedged light guide plate 20 after the sunlight 40 is incident at angle (30, 60) defined in polar coordinate system into the lens 10i, and it can be seen that before the sunlight 40 reaches the end portion of the wedged light guide plate 20 in −X direction, the sunlight 40 is reflected in Y direction five times. Since the structural design of the wedged light guide plate 20 is for the sunlight 40 performing total reflection transmission in Z direction, the reflection of the sunlight 40 in Y direction in the wedged light guide plate 20 may cause energy loss. Please refer to FIG. 5B which shows the lens 10j having different prism structure from the lens 10i, and then FIG. 6B shows the case where the sunlight 40 is incident into and propagates in the wedged light guide plate 20 after the sunlight 40 is incident at angle (30, 60) defined in polar coordinate system into the lens 10j, where before the sunlight 40 reaches the end portion of the wedged light guide plate 20 in −X direction, the sunlight 40 is reflected in Y direction twice. Comparing to FIG. 6A, the reflection times of the sunlight 40 in Y direction in the wedged light guide plate 20 significantly decrease, which can be referred as the collimation of the sunlight 40 in respect to the desired transmission direction (−X direction in FIGS. 6A and 6B). That is, the collimation defined herein is making the transmission direction of the sunlight 40 be parallel to the desired transmission direction. While using the lens 10j, the sunlight 40 still keeps the total reflection condition in Z direction. Therefore, after the lenses with different structures for different trajectory of the sunlight are added in the sunlight-collecting system, even though the trajectory of the sunlight varies with the variation of date or season, the sunlight-collecting system of the present invention can keep high efficiency of sunlight-collecting effect by reducing the reflection times of the sunlight 40 in undesired direction in the wedged light guide plate 20.

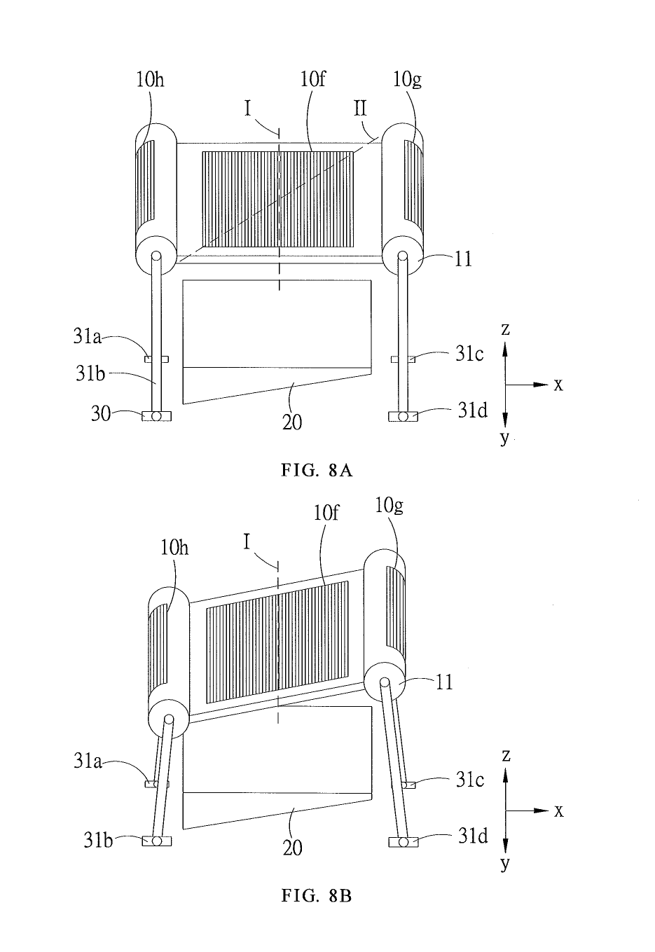

Please refer to FIGS. 7A and 7B which are overlooking structural schematic front views of the sixth embodiment of different lenses' rotation angles of a sunlight-collecting system of the present invention. FIG. 7A indicates that the type 11 is placed horizontally relative to the wedged light guide plate 20, and FIG. 7B indicates that the type 11 has a rotation angle relative to the wedged light guide plate 20. The holder 30 in the FIGS. 7A and 7B has feet 31a and 31b.

According to the aforementioned description, the present invention corresponds to different angles of incident sunlight occurred in different dates or seasons by the added rotation function. The present embodiment relates to how to use the added rotation function of the sunlight-collecting system of the present invention. In the embodiment, other than the preceding roller rotation function, the holder 30 can further elongate or shorten its feet 31a and 31b and other feet (here only feet 31a and 31b at one side are described, and the feet at another side change length correspondingly) so as to rotate the type 11 and further rotate the corresponding lenses. For example, in FIG. 7A, the feet 31a and 31b are of the same length, and the type 11 is placed horizontally relative to the wedged light guide plate 20. In FIG. 7B, the feet 31a shorten and the feet 31b elongate, in the meanwhile, the type 11 has a rotation angle relative to the wedged light guide plate 20, so that the lens which is assembled upon the desired position upon the type 11 also has a rotation angle relative to the wedged light guide plate 20 so as to achieve the preceding function of collimating sunlight to the transmission direction. In the holder 30, for example, the conjunction portion of the feet 31a and 31b and the roller may have a corresponding microstructure, but it does not the primary objective of the present invention, so unnecessary details are not given to avoid blurring the theme.

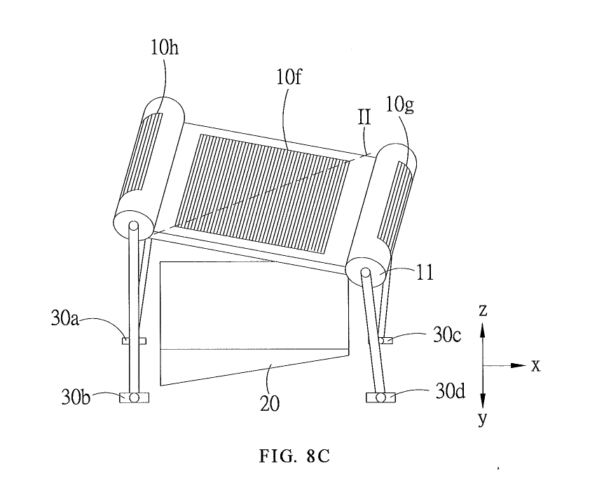

Please refer to FIGS. 8A to 8C which are structural schematic side views of the sixth embodiment of different lenses' rotation angles of a sunlight-collecting system of the present invention. In FIGS. 8A to 8C, the holder 30 has four feet 31a, 31b, 31c and 31d which can separately change length thereof or be inclined a certain angle so as to make the holder 30 perform multiple axis rotation to rotate the lens. FIG. 8A is the structural side view illustrating the case where the lens is not yet rotated and flatly positioned, FIG. 8B is the structural side view illustrating the case where the lens is rotated along the axis I in FIG. 8A by the holder, and FIG. 8C is the structural side view illustrating the case where the lens is rotated along the axis II in FIG. 8A by the holder.

In addition to have the monoaxial rotation function as described with FIGS. 7A and 7B, the holder 30 can further perform multiple axis rotation function depending on the design of feet 31A, 31B, 31C and 31D. For example, the structure of the sunlight-collecting system in FIG. 8A is in fact similar to that of the sunlight-collecting system in FIG. 4, where the lens 10f at the desired position is flatly positioned. In FIG. 8B, the feet 30a and 30b are shortened and slightly inclined inward, and the feet 30c and 30d are elongated and slightly inclined inward. Hence, the lens 10f can be rotated along the axis I in FIGS. 8A and 8B. In FIG. 8C, the feet 30b and 30c are substantially unchanged, the feet 30a is elongated and slightly inclined inward, and 30d is shortened and slightly inclined inward. Hence, the lens 10f can be rotated along the axis II in FIGS. 8A and 8C. It is noticeable that although FIGS. 8A to 8C only show the effect of two axis rotation, the effect of the monoaxial rotation is practically incorporated in the same structure in FIGS. 8A to 8C. Further, the feet 31A, 31B, 31C and 31D of the holder 30 of the sunlight-collecting system of the present invention can separately change length or incline a certain angle, so the lens in fact can be rotated along arbitrary axis so as to perform the multiple axis rotation function.

Though the multiple axis rotation function is akin to that used in the sunlight-collecting system of prior art as mention before, since the sunlight-collecting system can still replace the lenses after rotation, the multiple axis rotation function utilized in the present invention practically can have complementary effect together with the replacing of the lenses. That is, the sunlight-collecting system of the present invention can reduce the frequency of rotating the lens by replacing the lens; on the other hand, the sunlight-collecting system of the present invention can reduce the number of used lenses by including the lens rotation function. For example, even though the sunlight-collecting system is installed at high latitudes, it may only use the lens rotation function per mouth or per season to collimate the sunlight in a specific period, and the sunlight-collecting effect according the trajectory of the sun in daytime is provided by the lens replacing function. Therefore, unlike the sunlight-collecting system of prior art, it is not required to continuously rotate the lens or other light-collecting structure every day for the sunlight-collecting system of the present invention so as to achieve the effect of decreasing failure possibility and increasing reliability. Similarly, such multiple axis rotation function allows more flexibility of the sunlight-collecting system of the present invention, so that even though the sunlight-collecting system has specific requirement about angle for the installation, the structural design does not need to be modified and the sunlight-collecting system can obtain the same or similar light-collecting effect by rotating the lens.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A sunlight-collecting system, comprising:
a plurality of lenses changing an angle of incident sunlight;
a wedged light guide plate (LGP) receiving the incident sunlight passing through a lens of the plurality of lenses; and
a holder fixing the lens of the plurality of lenses at a desired position corresponding to the LGP;
wherein, structures, materials and the desired position of the lens and the LGP make the incident sunlight passing through the lens and then going into the LGP perform total internal reflection (TIR) transmission in the LGP and then concentrate at one end of the LGP, and the sunlight-collecting system changes the corresponding lens to the desired position to keep the above TIP transmission condition, depending on an initial angle of the incident sunlight.

2. The sunlight-collecting system as defined in claim 1, wherein the plurality of lenses are of different structures, so that different angle changes occur while the incident sunlight passes through different lenses of the plurality of lenses.

3. The sunlight-collecting system as defined in claim 2, wherein the plurality of lenses are made of different materials, so that the different angle changes occur while the incident sunlight passes different lenses through the plurality of lenses.

4. The sunlight-collecting system as defined in claim 2, wherein the plurality of lenses are structured in different prism arrays or cylindrical arrays.

5. The sunlight-collecting system as defined in claim 4, wherein the plurality of lenses are a plurality of membrane lenses.

6. The sunlight-collecting system as defined in claim 5, wherein the plurality of lenses are flexible and assembled upon a type or form a type, the type is assembled upon the holder, the holder is a roller structure, so that the sunlight-collecting system replaces the lens of the plurality of lenses corresponding the incident sunlight by scroll.

7. The sunlight-collecting system as defined in claim 6, wherein the sunlight-collecting system replace the lens with a corresponding structure, so that the incident sunlight passing through the lens is collimated.

8. The sunlight-collecting system as defined in claim 5, wherein the holder rotates the lens corresponding to the angle of the incident sunlight, so that the incident sunlight passing through the lens is collimated.

9. The sunlight-collecting system as defined in claim 8, wherein the sunlight-collecting system implements multiple axis rotation to rotate the lens.
